(19) United States
(12) Patent Application Publication
(10) Pub. No.: US 2006/0205507 A1
(43) Pub. Date: Sep. 14, 2006

(54) Video game system having dual-function wireless game controller

(75) Inventor: Mun Yee Ho, Hong Kong (HK)

Correspondence Address: GREENBLUM & BERNSTEIN, P.L.C., 1950 ROLAND CLARKE PLACE, RESTON, VA, 20191, US

(73) Assignee: P5 International Limited, of Hong Kong

(21) Appl. No.: 11/078,383

(22) Filed: Mar. 14, 2005

(51) Int. Cl. A63F 13/00

(52) U.S. Cl. 463/39

(57) ABSTRACT

A video game system including a portable main unit and a personal electronic unit for wirelessly controlling a video game played on the portable main unit and displayed on a display. The portable main unit connects to the display and can receive infrared video game control signals from the personal electronic unit. Further, the personal electronic unit includes a directional game controller, a set of assignable function keys, and an infrared transmitter for sending game control signals to the portable main unit. The personal electronic unit operates as a watch or other personal device until it is switched to a game mode, in which the assignable function keys and the directional game controller are used to operate the video game playing on the portable main unit and displayed on the display.

### BACKGROUND OF THE INVENTION

1. Field of the Invention

The present invention relates to a video game system for playing a video game on a display, such as, for example, a television cathode ray tube or crystal liquid display, including a portable main unit connectable to the display and a personal electronic unit which can communicate with the portable main unit to control the video game.

2. Discussion of Background and Other Related Information

As video game systems have become popular, a type of video game system which displays video games on a display has been widely used. Such a video game system typically includes a control unit (a joystick, for example) attached to the video game system via a wire. However, wired control units can easily become tangled and/or restrict the video game player's freedom to move around.

### SUMMARY OF THE INVENTION

In view of the above and other limitations of the related art, the present invention encompasses a video game system including a portable main unit which can connect to the display, and a personal electronic unit, such as a time piece, which can be worn or carried by a user and which serves at least a dual purpose—for example, operating as a time piece in a watch mode, and as a video game controller which sends game control signals to the portable main unit when the personal electronic unit is switched to a game mode. Furthermore, the personal electronic unit may include a directional game pad (for example, a dual-axis cross-shaped game pad) as well as several assignable function keys. The assignable function keys may operate various time piece functions when the personal electronic unit is in the watch mode, and may be reassigned to operate various game functions used in the video game shown on the display when the personal electronic unit is switched to the game mode.

According to one aspect of the present invention, the personal electronic unit may be switched from a watch mode to a game mode by depressing a control key on the watch. As a benefit, control circuitry may be simplified and manufacturing costs may be reduced.

According to another aspect of the present invention, the portable main unit may cause the display to emit a particular signal (for example, by displaying a pattern in the infrared spectrum on a screen of the display, outside of the range of human visual perception) which, when detected by the personal electronic unit, causes the personal electronic unit to automatically switch from the watch mode to the game mode. As a further convenience, the personal electronic unit may also be programmed to automatically switch back from the game mode to the watch mode when the game mode activating signal is no longer detected by the personal electronic unit. Therefore, switching between modes may be facilitated and the switching can be automatic without requiring user intervention.

According to another aspect of the present invention, a video game system for playing a game using a display includes a portable main unit which communicates with the display and includes a first wireless unit which receives a wireless signal, a personal electronic unit operable by a user in a first mode or a second mode and including a second wireless unit which transmits the wireless signal, a directional input unit which receives directional input from the user, a plurality of assignable function keys which control an operation of the personal electronic device in the first mode and which control the game in the second mode, and a control key which toggles the personal electronic unit between the first mode and the second mode.

According to another aspect of the present invention, a video game system for playing a game using a display includes a portable main unit detachably connected to a display, a personal electronic unit operable in a time piece mode or a game mode, the personal electronic unit communicating with the portable main unit via a wireless signal and including a game pad which receives directional game input from a user, a first assignable function key which controls one of a stopwatch function in the time piece mode and a start function in the game mode, and a second assignable function key which toggles a timepiece display on the personal electronic unit in the time piece mode or a select function in the game mode, the personal electronic unit selectionally entering the game mode when the personal electronic unit receives a signal from the portable main unit and selectionally entering the time piece mode when the personal electronic unit does not receive the signal from the portable main unit.

According to another aspect of the present invention, a method for playing a video game in a system including a display, a personal electronic unit and a portable main unit transmitting an image signal to the display, includes assigning a first and a second time piece function of the personal electronic unit to a first assignable function key and a second assignable function key, respectively, of the personal electronic unit, controlling the first or second time piece function of the personal electronic unit via the first or second assignable function key in a time piece mode, toggling between the time piece mode and a game mode, transmitting a wireless signal from the personal electronic unit to the portable main unit when toggling from the time piece mode to the game mode, assigning a first and a second game function of the video game to the first and the second assignable functions key, respectively, when toggling from the time piece mode to the game mode, and controlling the first or second game function of the video game via the first or second assignable function key in the game mode.

### BRIEF DESCRIPTION OF THE DRAWINGS

The above objects, and other features and advantages of the present invention will become more apparent in view of the following detailed description when taken in conjunction with the drawings, in which:

FIG. 1 is a plan view illustrating a video game system according to an embodiment of the present invention;

FIG. 2A is a plan view illustrating a personal electronic unit employed with the video game system shown in FIG. 1;

FIG. 2B is a plan view illustrating a personal electronic unit having a key chain form factor, according to an embodiment of the present invention;

FIG. 3A is a perspective view illustrating a portable main unit employed with the video game system shown in FIG. 1;

FIG. 3B is a perspective view illustrating another embodiment of the present invention;

FIG. 3C is a schematic view illustrating the portable main unit shown in FIG. 1 plugged into a radio frequency input of a television, according to another embodiment of the present invention;

FIG. 4 is a block diagram illustrating an organization of a system according to an embodiment of the present invention; and

FIGS. 5A-5D are schematic circuit diagrams showing circuits implementing the personal electronic unit and portable main unit according to various embodiments of the present invention.

### DETAILED DESCRIPTION OF THE PREFERRED EMBODIMENTS

Exemplary embodiments of the present invention are described in detail below with reference to the drawings, in which like reference numbers denote like features.

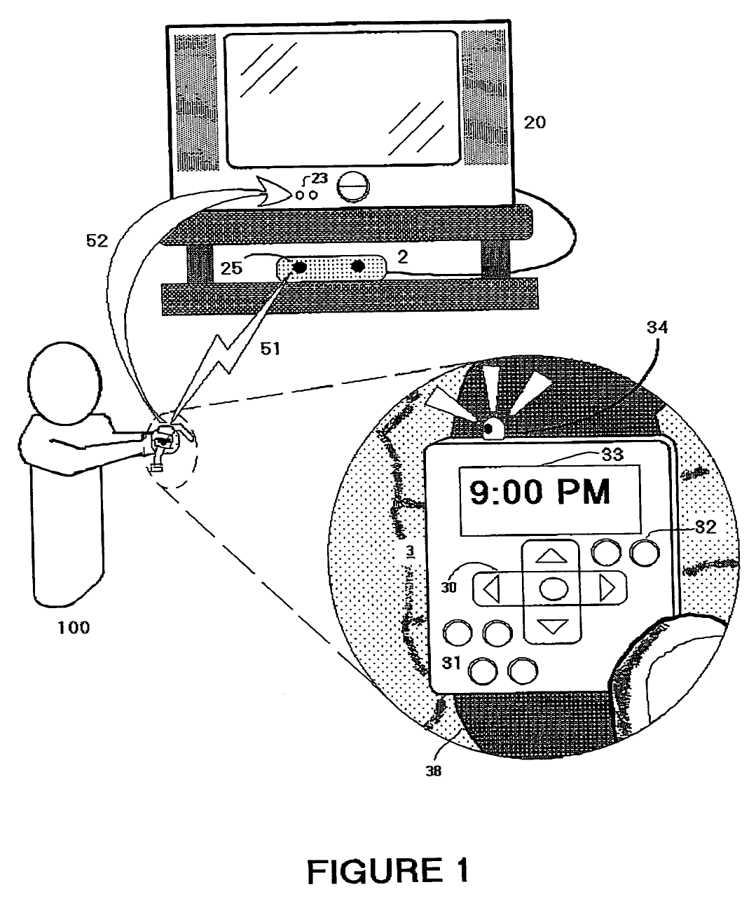

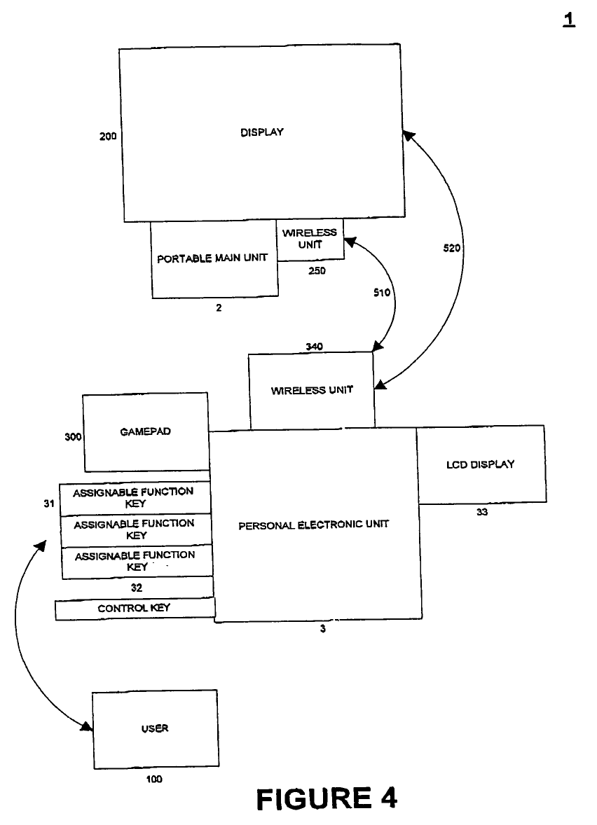

FIG. 4 shows a structural organization of an embodiment of the present invention. A personal electronic unit 3 receives input from a user 100 via a control key 32, assignable function keys 31, or directional control unit 300 (hereinafter, exemplified as a dual-axis cross-shaped gamepad 30, as shown in FIG. 1). The personal electronic unit 3 communicates with a display 200 using a wireless unit 340 (hereinafter exemplified as an infrared transmitter 34 in FIG. 1) with a portable main unit 2 having another wireless unit 250 (hereinafter exemplified as an infrared receiver 25 in FIG. 1) over a wireless channel 510, and the portable main unit 2 displays a video game on the display 200. In some embodiments, the personal electronic unit 3 can communicate with the display 200 over another wireless channel 520.

FIG. 1 illustrates a video game system 1 according to a first embodiment of the present invention, and includes a detailed view of the personal electronic unit 3 in a user's 100 hands. The user 100 holds the personal electronic unit 3, which is typically worn around the wrist as a watch or time piece (and is hereinafter referred to as an example of a personal electronic unit 3). When the personal electronic unit 3 is toggled to a game mode and a portable main unit 2 is operatively connected to the display 200 (such as, for example, the television 20 in FIG. 1), the personal electronic unit 3 sends game control signals via a first infrared (IR) channel 51.

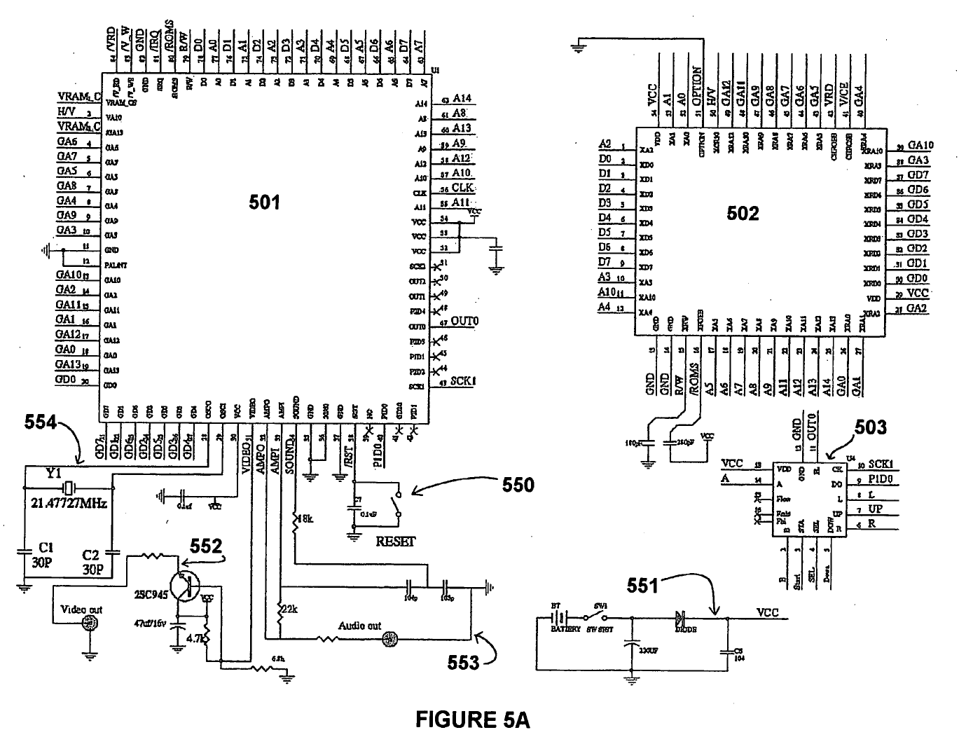

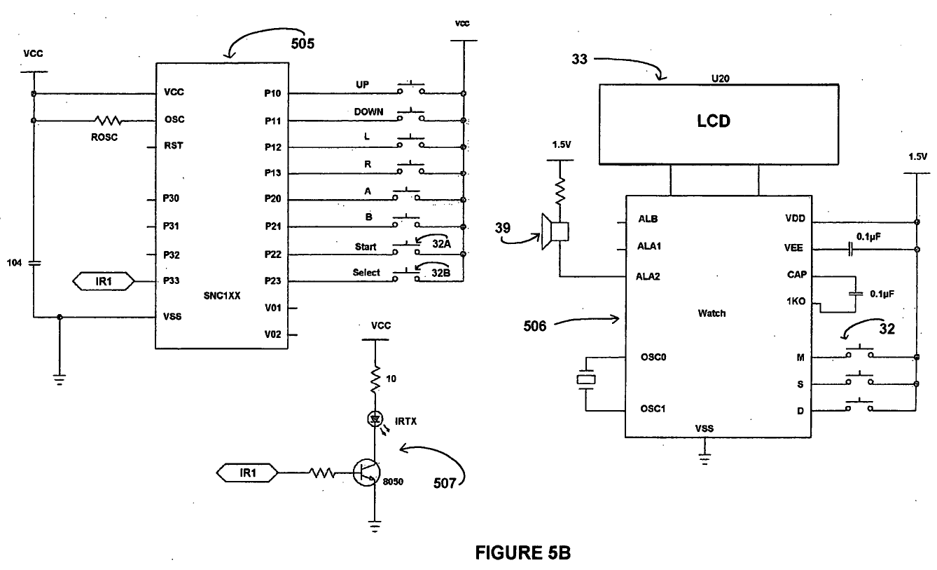

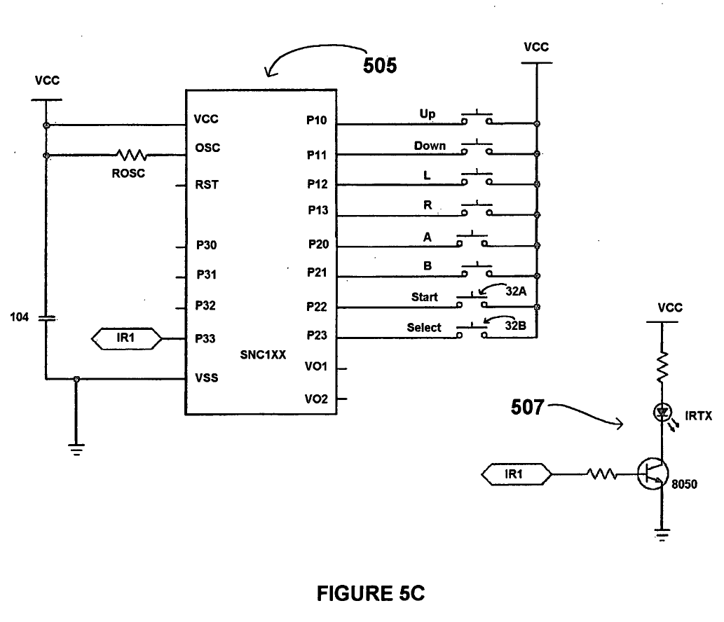

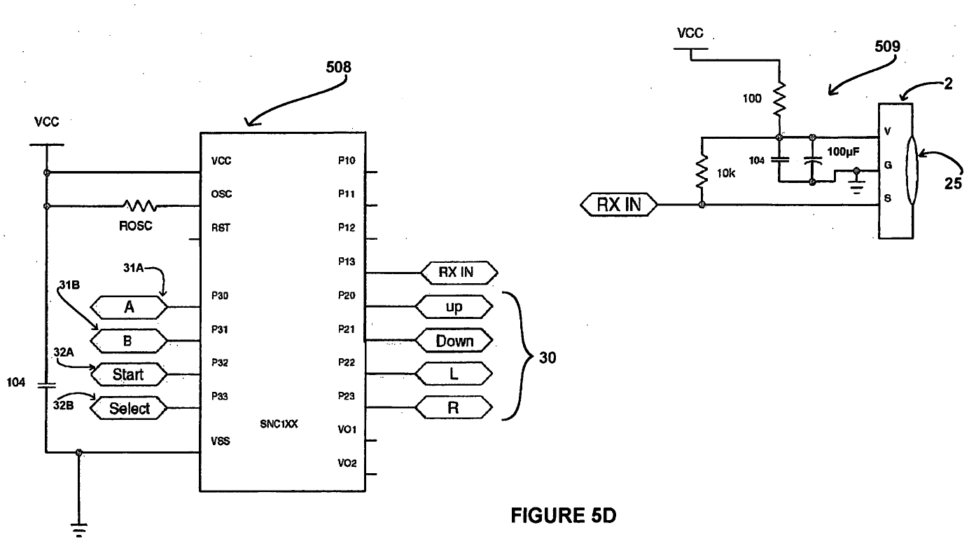

In the first embodiment, the portable main unit 2 drives the television 20 (functioning as the display 200) and includes an IR receiver 25, and the personal electronic unit 3 sends IR signals to the IR receiver 25 via the IR transmitter 34. The IR transmitter 34 of the personal electronic unit 3 may be implemented using, for example, an IR light-emitting diode (LED) driven by appropriate circuitry (as shown in FIGS. 5A-5D, for example), and the IR receiver 25 may correspondingly be implemented using an IR-frequency photosensor attached to appropriate circuitry within the portable main unit 2. Further, either one or both of the portable main unit 2 and the personal electronic unit 3 may include an IR transceiver capable of both transmitting and receiving IR signals.

However, it is understood that variations may occur with respect to the IR transmitter 34 and IR receiver 25 without departing from the scope and/or spirit of the present invention. Further, alternative transmission schemes, such as radio frequency (RF) may be used, for example.

For user control and/or interaction, the time piece 3 may include a multi-position game pad, such as, for example, a four-direction game pad 30, for sending directional control signals used in a video game played on the portable main unit 2, as well as assignable function keys 31, a control key 32, and an LCD display 33. The assignable function keys 31 may be assigned to time piece-related functions when the personal electronic unit 3 is in the watch mode: for example, one of the assignable function keys 31 may be a stopwatch start/stop button, and another assignable function key 31 may toggle the LCD display 33 between displaying the time of day or the date, etc. When the personal electronic unit 3 switches to the game mode, the same assignable function keys 31 may be reassigned to functions corresponding to the video game played on the portable main unit 2 and displayed on the television 20.

For example, the assignable function key 31 which functioned as the stopwatch start/stop function in the watch mode may be reassigned to a video game “Start” or “Select” function in the game mode. Other examples of watch mode functions include setting or resetting the time or date, and other video game functions may include making an initial selection among various video games available for play, or a “Fire” button as commonly used in arcade-style video games. Further, the personal electronic unit 3 may function as a personal digital assistant (PDA) similar to a PALM PILOT® or the like.

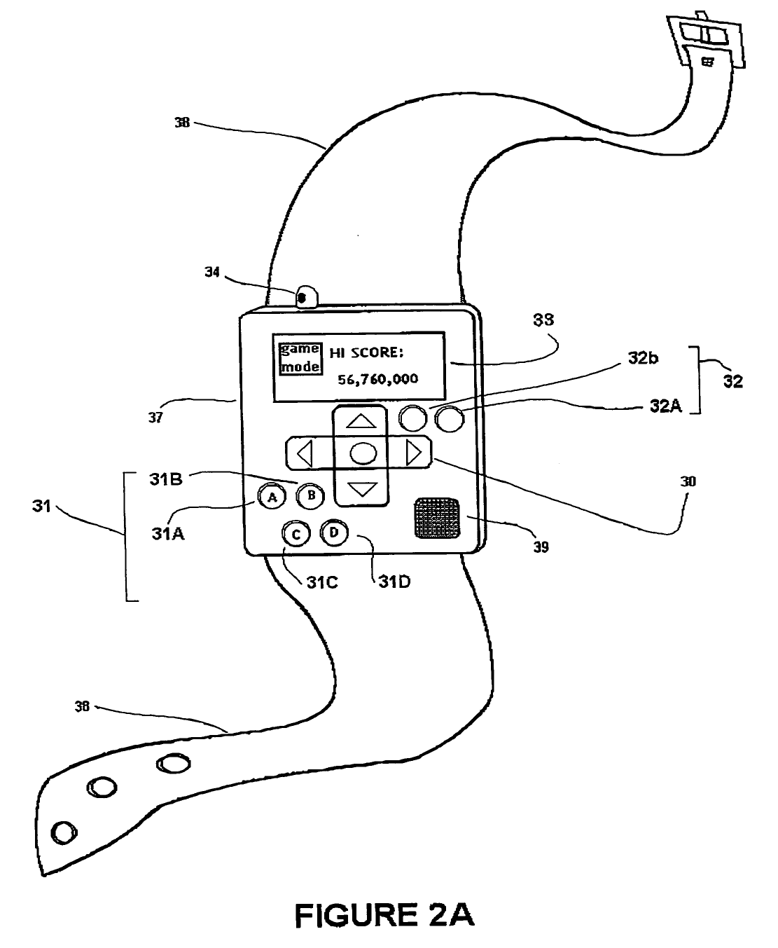

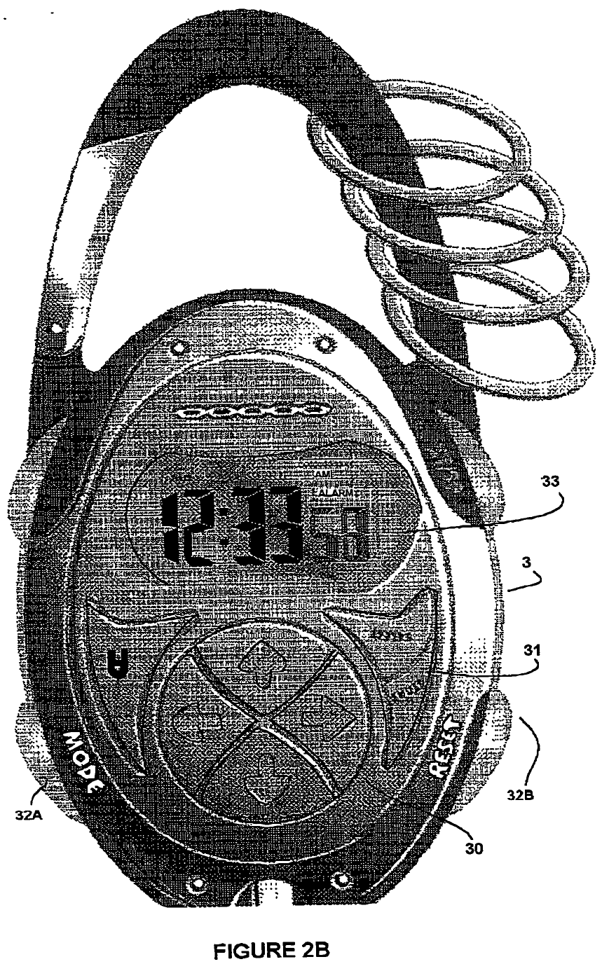

In another embodiment of the present invention, all or any subset and/or permutation of the four-direction game pad 30 and the control key 32 may also be included among the assignable function keys 31. Alternatively, any or all of the assignable function keys 31 may be permanently assigned to a particular timepiece or game function, regardless of whether the personal electronic unit 3 is in the watch mode or in the game mode. Also, as shown in FIG. 2A, the personal electronic unit may include more than two assignable function keys (such as assignable function keys 31A, 31B, 31C, and 31D), for example.

Although the personal electronic unit 3 shown in FIGS. 1 and 2A includes a control key 32 for toggling between the watch mode and the game mode, as an alternative, the portable main unit 2 may cause the television 20 to display a particular pattern (which may be of a particular wavelength of light, or of a particular shape, or which may flash according to a communication protocol, such as, for example, RS-232, etc.) which is detected by the personal electronic unit 3 via a second IR channel 52. In this implementation, the personal electronic unit 3 automatically switches to the game mode when the appropriate pattern is detected over the infrared channel 52, and reverts to the watch mode when the pattern is no longer detected or when the user hits the control key 32 to explicitly revert to the watch mode.

FIG. 2A illustrates an example of the personal electronic unit 3 shown in FIG. 1, as a time piece switched to the game mode. As shown in FIG. 2A, the time piece includes a watch body 37 and watch straps 38. The time piece is typically worn around the wrist of the user 100 for use as a watch until the time piece is switched to the game mode for use as a video game controller.

As shown in FIG. 2B, which shows another example of a personal electronic unit 3, the personal electronic unit 3 may be designed as a key chain rather than a watch with straps. Any such suitable convenient and/or popular consumer electronics device may be similarly used as the personal electronic unit 3.

According to one aspect of the present invention, the portable main unit 2 may store one or more games internally, or, according to another aspect, the portable main unit 2 may include a cartridge slot (not shown) or other machine-readable interchangeable media system for playing various games stored on the medium. For example, the portable main unit 2 may include a NINTENDO® GAME CUBE® or GAME BOY® system, or a SONY® PLAYSTATION®, etc.

If the video game run on the portable main unit 2 does not require use of all of the assignable function keys available on the personal electronic unit 3, the portable main unit 2 may transmit a signal to the personal electronic unit 3 which disables any unused assignable function keys during game play. As a result, unintentional key presses caused by an accidental key press by the user can be prevented, and power may also be saved by driving only the appropriate assignable function keys.

Also, as shown in FIG. 2A, the personal electronic unit 3 may include more than one control key (such as, for example, control keys 32A and 32B).

According to another aspect of the present invention, the portable main unit 2 may transmit signals which cause the personal electronic unit 3 to beep or emit a sound from a speaker 39 (see FIG. 2A) when appropriate for the game played on the portable main unit 2, or cause the personal electronic unit 3 to display an alphanumeric or graphical image on an LCD display 33 (or other appropriate small display) of the personal electronic unit 3 which corresponds to the video game being played on the portable main unit 2.

A further aspect of the present invention includes the inclusion of a vibration-generating unit (for example, a motor which rotates an off-balance mass) in the personal electronic unit 3 (not shown) for generating a forced-feedback or tactile interaction in response to signals from the portable main unit 2. Accordingly, user interaction and the user's game play experience may be enhanced.

According to another aspect of the present invention, the portable main unit 2 may acquire a precise time reading (for example, when the portable main unit 2 is connected to the Internet and receives an updated time of day via NTP, the network time protocol). The portable main unit 2 can forward the updated time to the personal electronic unit 3 via the display 200. Such time updating may occur while the user 100 is playing the video game on the portable main unit 2 using the personal electronic unit 3 as a game controller, for example.

Further, as shown in FIG. 2A, the personal electronic unit 3 may track a high score of a video game played on the portable main unit 2 and transmit the high score or a high score list to the portable main unit 2 to be displayed on the display 200 at an appropriate time (or, conversely, the portable main unit 2 may track the high score list and transmit it to the personal electronic unit 3 for display on the LCD screen 33, for example). Accordingly, the user can keep track of his or her high score no matter where or which system he or she plays on, especially when the personal electronic unit 3 can interact with any portable main unit 2 (such as a portable main unit 2 that belongs to a friend or a portable main unit 2 located at a public place, such as, for example, a restaurant or an arcade).

The protocol used for communicating wirelessly (using BLUETOOTH, for example) or via infrared between the personal electronic unit 3 and the portable main unit 2 may be a serial protocol of either full or half duplex, and the infrared protocol or serial protocol may be an industry standard, such as RS-232 (serial), USB, IEEE-1394 or the like. Depending on the level of security selected, the wireless protocol may be transmitted in clear text or as ciphertext.

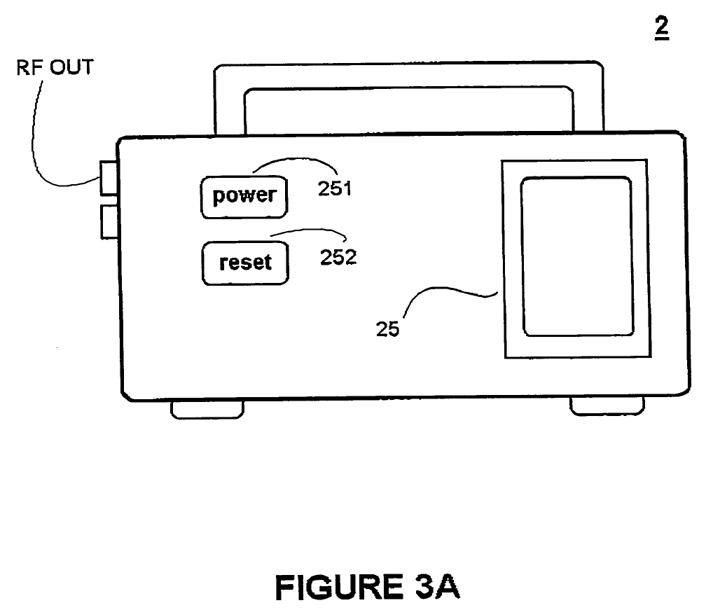

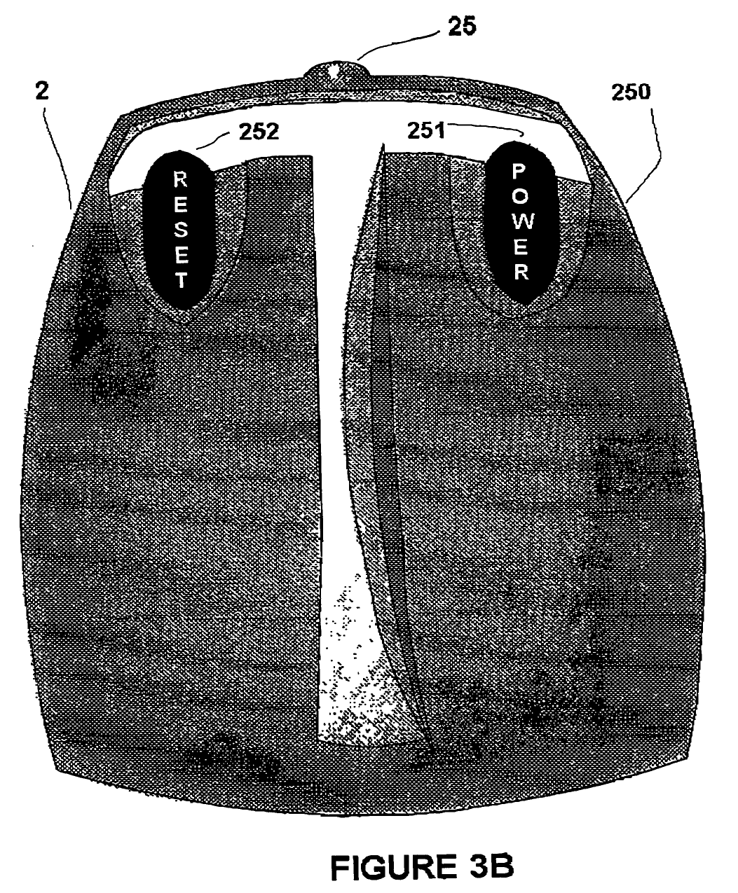

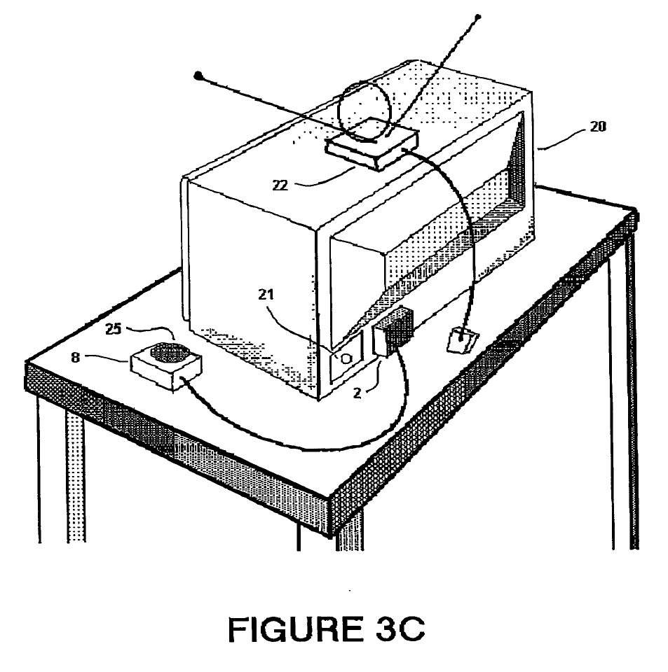

FIG. 3B shows a portable main unit 2 according to an embodiment of the present invention which includes a compact body 250, a power button 251 for turning the portable main unit 2 on or off, a reset button 252 for resetting a video game played on the portable main unit 2, and an infrared receiver 25 for receiving infrared signals for controlling the video game.

As shown in FIG. 3C, according to an embodiment of the present invention the portable main unit 2 may have a main unit housing with a form factor such that the portable main unit 2 can be plugged directly into a radio frequency (RF) input 21 of a television 20. Such a main unit housing allows the portable main unit 2 to be easily transported and quickly connected to any television or other display 200 using an RF frequency input, and permits rapid game play in a variety of locations, either public or private.

Alternatively, the portable main unit 2 may be designed to interface to the display 200 via another video signal input format, such as, for example, a composite, s-video, component, RGB, VGA, DVI, HDMI, and/or IEEE-1394 signal. It is understood that variations in the manner of interfacing the portable main unit 2 to the display 200 may be made without departing from the scope and/or spirit of the invention.

Further, as shown in FIG. 3C, the portable main unit 2 may include a dongle or extension 8 which extends around to the front of the television 20, for example, so that the IR receiver 25 is not blocked from receiving infrared or other wireless signals (51 or 52) by the body of the television 20 while the portable main unit 2 is plugged into the RF input 21 of the television 20.

According to another aspect of the present invention, the portable main unit 2 may cause the display 200 to emit or display a pattern representing an identification code or an encryption key. If the personal electronic unit 3 detects the IR pattern but does not recognize the identification code, or does not have a corresponding key matching the encryption key, the portable main unit 2 may disregard signals from the personal electronic unit 3 (or vice versa). Therefore, digital rights management (DRM) can be secured, and the user 100 avoids the inconvenience of the personal electronic unit 3 switching to the game mode when in proximity to a portable main unit 2 which is not intended to interact with the user's personal electronic unit 3. In such a system, the user 100 can unplug an antenna 22 or other such device from the RF input 21 (as an example of a video signal input connector), and then plug the portable main unit 2 into the RF input 21 to begin game play.

According to another aspect of the present invention in reference to FIG. 1, the personal electronic unit 3 can send an infrared signal 52 via the IR transmitter 34 which is detected by an IR sensor 23 (as an example of a remote control infrared unit) at the television 20. Accordingly, the signal 52 sent from the personal electronic unit 3 to the television 20 can be set in advance when the personal electronic unit 3 is manufactured or, alternatively, may be selected by the user 100 to a remote control code corresponding to the particular make and/or model of the television 20 As a result, the personal electronic unit 3 can function as a watch, a game controller and a universal remote control for controlling various consumer products (in this example, the television 20) which receive infrared remote control commands, all in a single unit.

As an example, the user 100 may attach a portable main unit 2 to a television 20 through a suitable digital signal connection, such as, for example, DVI or HDMI, and the portable main unit 2 may detect the particular make and model of the display 200 (for example, a SAMSUNG HL-P5663 television or SONY GDM-C520K monitor). Once the make and model of the display 200 is detected by the portable main unit 2, the portable main unit 2 can transmit a signal 51 to the personal electronic unit 3, which signal 51 assigns a power on/power off remote control function of the display 200 to one of the assignable function keys 31. Further, another one of the assignable function keys 31 may similarly be assigned as a channel selector, source selection or volume control remote control function of the display 200. By manipulating the various assignable function keys 31 and/or the control key 32 of the personal electronic unit 3, the user 100 can perform various remote control functions, such as, for example, turning on the television 20 or changing the selection of the television 20.

Regarding the respective transmitter 34 and IR receiver 25 in the personal electronic unit 3 and the portable main unit 2, appropriate circuitry may be implemented using various electronic components, such as, but not limited to, for example, integrated circuits and/or discrete logic components (for example, as shown in FIGS. 5A-5D). Alternatively, a microcontroller, such as, for example, a 68HC11 or X-SCALE microprocessor may be used for video game or control purposes. A customizable device, such as a field-programmable gate array (FPGA) or an application-specific integrated circuit (ASIC) may also be used to implement all or part of the appropriate circuitry.

Although the directional keys 30 of the personal electronic unit 3 have been described as a dual-axis cross-shaped game pad, directional control may alternatively be achieved using a roller ball, joystick or any other directional control device.

The portable main unit 2 may derive power through an AC/DC converter (not shown) attached to a source of electrical power, or may include a battery, or may derive power directly from the display 200 to which it attaches. The personal electronic unit 3 may also use a battery, solar cell, fuel cell or any other suitable portable power supply.

The display 200 may be a traditional 4:3 aspect ratio television device or a computer monitor such as, for example, VGA, or a 16:9 aspect ratio wide screen monitor. The display 200 may be implemented using cathode ray tube, projection, LCD, plasma, LED, SED, or any other display technology suitable for video game use. Further, as noted above, the connection between the display 200 and the portable main unit 2 may be RF, VGA, DVI, HDMI, or any other interconnection suitable for displaying images from the portable main unit 2 on the television 20. An auxiliary link (not shown) between the display 200 and the portable main unit 2 may also be achieved using USB, parallel, IEEE-1394, serial, BLUETOOTH or any other type of data interconnection suitable for video and/or data communication.

Software for operating either the portable main unit 2 or the personal electronic unit 3 may be stored in any suitable type of non-volatile memory (NVRAM) using any technology, such as, but not limited to, FLASH, electronically-erasable programmable read-only memory (EEPROM), battery-backed random-access memory (RAM), magnetic or optical medium such as compact disc (CD) or digital versatile disc (DVD), or any other type of storage medium suitable for control or game code.

As shown in FIG. 5A, for example, a main unit integrated circuit 501 effects the functions of the portable main unit 2 according to an embodiment of the present invention. In this example, the main unit integrated circuit 501 connects to a video random-access memory (VRAM) subsystem (not shown) via a signal line/VRD (to indicate a read operation to the VRAM subsystem), a signal line/VW (to indicate a write operation to the VRAM subsystem), VRAM address signal lines GA0 through GA13 (to signal an address in the VRAM subsystem), VRAM data signal lines GD0 through GD7 (for inputting or outputting a 8-bit data word to or from the VRAM subsystem), and signal lines VRAM_{L}C and VRAM_{H}C, respectively, for storing and displaying video game images on a display 200 (See FIG. 1). In addition, the main unit integrated circuit 501 can receive processor interrupt requests via the signal line IRQ.

The main unit integrated circuit 501 may also include a reset switch circuit 550 for resetting the video game via a signal line/RESET, an oscillator circuit 554 containing capacitors C1 and C2 and an oscillator Y1 (operating at, for example, 21.47727 megahertz), a video out circuit 552 connected via a signal line VIDEO, and an audio circuit 553 connected via signal lines SOUND, AMP0 and AMP1. The main unit integrated circuit 501 may receive system-wide timing input from a system clock (not shown) via a signal line SCK1. A common reference voltage may be provided to the main unit integrated circuit 501 via the signal line GND, and an internal clock signal may be inputted via a signal line CLK.

Further, the main unit integrated circuit 501 may store and read a program (such as, for example, video game program code) data into or out of a main memory subsystem 502, which can be implemented as an NVRAM (as discussed above), RAM, read-only memory (ROM), a VRAM, or a combination thereof (such as, for example, an integrated circuit containing both a RAM and a VRAM, as illustrated in FIG. 5A). Communication between the main unit integrated circuit and the main memory subsystem 502 occurs via main memory address signal lines A0 through A14 (for indicating a main memory address of the main memory subsystem 502 to be read from or written to), main memory data signal lines D0 through D7 (for reading or writing an 8-bit data word to or from the main memory subsystem 502), and a signal line R/W (for signaling whether a read or write operation is to be performed to the main memory subsystem 502).

When the main memory subsystem 502 also includes a VRAM, as illustrated in FIG. 5A, the VRAM address signal lines GA0 through GA12 and the VRAM data signal lines GD0 through GD7 may be interconnected between the main unit integrated circuit 501 and the main memory subsystem 502. In the embodiment shown in FIG. 5A, for example, the highest VRAM address signal line GA13 from the main unit integrated circuit 501 may be left unconnected to the main memory subsystem 502 because the main memory subsystem 502 may only contain, for example, 8192 data words of capacity (and thus be fully addressable by the signal lines GA0 through GA12 without needing GA13); however, the present invention is not limited to such an arrangement or capacity, and it is understood the main memory subsystem 502 may alternatively contain any appropriate capacity, and that either more or fewer VRAM address signal lines (e.g., GA0 through GA13) than are illustrated in FIG. 5A may be interconnected between the main unit integrated circuit 501 and the main memory subsystem 502, without departing from the scope or spirit of the present invention. The signal line H/V may also be interconnected between the main unit integrated circuit 501 and main memory subsystem 502, for toggling between, for example, high or low voltage operation.

As shown in FIG. 5A, a power supply circuit 551 supplies a constant voltage, V_{cc}, used in the portable main unit 2. Also, a game controller interface circuit 503 may be connected to the main unit integrated circuit 501, which receives input from, for example, the four-direction game pad 30 via the infrared receiver 25 through the signal lines L, UP, DN, and R and may receive input from at least two of the assignable function keys 31 via the signal lines A and B (although not illustrated in FIG. 5A, it is understood that further signal lines corresponding to further degrees of directional control and/or further assignable function keys may also be included).

The game controller interface circuit 503 may encode a controller state corresponding to each of the input signal lines L, UP, DN, R, A, and B, etc., and output a resulting state code to the main unit integrated circuit 501 via the signal line OUT0. Further, the game controller interface circuit 503 may signal to the main unit integrated circuit 501 that a state code is available by appropriately driving a signal line PID0.

Alternatively, when the personal main unit 2 can receive game control signals from more than one player in a videogame (such as, for example, in a two-player video game e.g., PONG®), the game controller interface circuit 503 may signal to which personal electronic unit 3 (see FIG. 1) a particular state code sent via the signal line (or signal lines) OUT0 belongs. Accordingly, circuit production costs may be reduced by using a single game controller interface circuit 503 to interface with more than one personal electronic unit 3.

Although the main unit integrated circuit 501, the main memory subsystem 502, the game controller interface circuit 503 and the power supply circuit 551 are discussed individually, it is understood that all or any subset and/or permutation thereof may be combined in an integrated circuit and/or circuit board, or may be implemented discretely and/or separately from any combination or subset of the others.

FIG. 5B illustrates a schematic for a transmitting circuit 505 and a watch control circuit 506 of the personal electronic unit 3 (see FIG. 1) according to another embodiment of the present invention, for wirelessly interfacing with, for example, a portable main unit 2 with the main unit Integrated circuit 501, the main memory subsystem 502, the game controller interface circuit 503 and the power supply circuit 551 shown in FIG. 5A (although the transmitting circuit 505 and the watch control circuit 506 illustrated in FIG. 5B may alternatively interface with any other portable main unit 3 according to the present invention, and is not limited to the embodiment shown in FIG. 5A).

The transmitting circuit 505 can transmit infrared game control signals to the phototransistor 551 of the main integrated circuit 501 of the portable main unit 2, using the photodiode driving circuit 507. For example, the transmitting circuit 505 can respond to the assignable function keys (such as, for example, the assignable function keys 31 shown in FIG. 2A), and may be connected to a photodiode driving circuit 507 for outputting and/or inputting infrared signals, as shown in FIG. 5B. The watch control circuit 506 is also connected to the speaker 39 for emitting appropriate sounds such as beeps, music, tones, or sound effects when in the watch mode or the game mode.

FIG. 5C illustrates a detailed schematic diagram of the transmitting circuit 505 and photodiode driving circuit 507, in which two of the assignable function keys 31 are designated “A” and “B, ” respectively, and four directions of a directional game pad 30 (see FIG. 2A) are designated “Up,” “Down,” “L” (for Left), and “R” (for Right), respectively. Further, the control keys 32A and 32B (see FIG. 2A) are connected to the transmitting circuit 505 via signal lines Start and Select, respectively. The transmitting circuit 505 may drive the photodiode driving circuit 507 by a connection IR1, such that a signal output by the transmitting circuit 505 on the connection IR1 is converted to an infrared signal emitted from an IR-wavelength photodiode IRTX, for example.

FIG. 5D illustrates a schematic diagram of an example of a receiving game control circuit 508 which may be employed by the present invention. The receiving game control circuit 508 may receive input from the four-directional game pad 30 (see FIG. 1, for example) to control a video game played on the portable main unit 2. The receiving game control circuit 508 connects to a receiving circuit 509, which debounces and filters an infrared signal received by the IR receiver 25 of the portable main unit 2. The receiving circuit 509 then transmits the debounced, filtered signal to the receiving game control circuit 508 via a circuit connection RX IN. Upon receiving the debounced, filtered signal, the receiving game control circuit 508 transmits signals to the game controller interface circuit 503 (see FIG. 5A) via circuit connections Up, Down, L, R, A and B, which may be connected to corresponding signal lines of the game controller interface circuit 503.

Although a few embodiments of the present invention have been described and taught above, the present invention is not limited necessarily thereto. Rather, the scope of the claimed invention is anticipated to cover all modifications, alternate constructions, and equivalents within the spirit and scope of the invention as described in general terms above, and as set forth in the appended claims.

What is claimed:

1. A video game system for playing a game using a display, the video game system comprising:
a portable main unit which communicates with the display and includes a first wireless unit which receives a wireless signal;
a personal electronic unit operable by a user in one of a first mode and a second mode and including a second wireless unit which transmits the wireless signal, a directional input unit which receives directional input from the user, a plurality of assignable function keys which control an operation of the personal electronic device in the first mode and which control the game in the second mode, and a control key which toggles the personal electronic unit between the first mode and the second mode.

2. The video game system according to claim 1, further comprising:
a first assignable function key among the assignable function keys, which selects among a plurality of game modes when the personal electronic unit is in the second mode.

3. The video game system according to claim 1, wherein the portable main unit further comprises:
a wireless transmitter which transmits a plurality of game control signals to the personal electronic unit, the personal electronic unit assigning each of the game control signals to a corresponding assignable function key among the assignable function keys.

4. The video game system according to claim 1 wherein the first and second wireless units communicate via infrared.

5. The video game system according to claim 1, wherein the personal electronic unit includes a timepiece.

6. The video game system according to claim 1, further comprising:
a first assignable function key among the assignable function keys, which starts a stopwatch count in the first mode and which controls a game start function in the second mode; and
a second assignable function key among the assignable function keys, which sets a time of day in the first mode and which controls a game select function in the second mode.

7. The video game system according to claim 1, further comprising:
a portable main unit housing which includes the portable main unit and which connects to a video signal input connector of the display.

8. The video game system according to claim 1, further comprising:
a remote control infrared unit connected to the display and which switches the display off when the remote control infrared unit receives a remote control signal; and
a display power key among the plurality of assignable function keys, which display power key causes the portable electronic unit to transmit the remote control signal to the remote control infrared unit when the display power key is actuated.

9. The video game system according to claim 1, wherein the portable main unit causes the display of a pattern on a screen of the display which encodes a time signal,
the personal electronic unit detecting the pattern and updating a time setting of the personal electronic unit based on the time signal encoded in the pattern.

10. The video game system according to claim 1, further comprising:
a dongle which includes the first wireless unit and connected to the portable main unit,
the dongle extending from a rear to a front of the display.

11. A video game system for playing a game, the video game system comprising:
a portable main unit detachably connected to a display;
a personal electronic unit operable in one of a time piece mode and a game mode, the personal electronic unit communicating with the portable main unit via a wireless signal and including a game pad which receives directional game input from a user, a first assignable function key which controls one of a stopwatch function in the time piece mode and a start function in the game mode, and a second assignable function key which toggles one of a timepiece display on the personal electronic unit in the time piece mode and a select function in the game mode,
the personal electronic unit selectionally entering the game mode when the personal electronic unit receives a signal from the portable main unit and selectionally entering the time piece mode when the personal electronic unit does not receive the signal from the portable main unit.

12. The video game system according to claim 11, further comprising:
a third assignable function key among the assignable function keys, which selects among a plurality of game modes when the personal electronic unit is in the game mode.

13. The video game system according to claim 11, further comprising:
a portable main unit housing which includes the portable main unit and which connects to a video signal input connector of the television.

14. The video game system according to claim 11, further comprising:
a remote control infrared unit connected to the television and which switches the television off when the remote control infrared unit receives a remote control signal; and
a display power key among the plurality of assignable function keys, which display power key causes the personal electronic unit to transmit the remote control signal to the remote control infrared unit when the display power key is pressed.

15. The video game system according to claim 11, further comprising:
a dongle connected to the portable main unit which extends from a rear to a front of the display, which receives an infrared signal from the watch.

16. The video game system according to claim 11, wherein the portable main unit causes the display of a pattern on a screen of the display which encodes a time signal,
the personal electronic unit detecting the pattern and updating a time setting of the personal electronic unit based on the encoded time signal.

17. A method for playing a video game in a system including a display, a personal electronic unit and a portable main unit transmitting an image signal to the display, comprising:
assigning a first and a second time piece function of the personal electronic unit to a first assignable function key and a second assignable function key, respectively, of the personal electronic unit;
controlling one of the first and second time piece function of the personal electronic unit via one of the first and second assignable function key in a time piece mode;
toggling between the time piece mode and a game mode;
transmitting a wireless signal from the personal electronic unit to the portable main unit when toggling from the time piece mode to the game mode;
assigning a first and a second game function of the video game to the first and the second assignable functions key, respectively, when toggling from the time piece mode to the game mode; and
controlling one of the first and second game function of the video game via one of the first and second assignable function key in the game mode.

18. The method according to claim 17, further comprising:
actuating a control key at the personal electronic unit,
the toggling between the time piece mode and the game mode occurring in response to the actuating of the control key.

19. The method according to claim 17, further comprising:
encoding a time signal in a pattern;
displaying the pattern on a screen;
detecting and decoding the pattern; and
updating a time setting based on the time signal encoded in the pattern.
